(19) United States
(12) Patent Application Publication
(10) Pub. No.: US 2009/0100687 A1
(43) Pub. Date: Apr. 23, 2009

(54) Multi-blade cutting apparatus

(76) Inventor: Joseph Mills, Holladay, UT (US)

Correspondence Address: BRETT J. DAVIS, P. O. BOX 1909, SANDY, UT, 84091, US

(21) Appl. No.: 11/975,394

(22) Filed: Oct. 18, 2007

(51) Int. Cl. B26B 3/04

(52) U.S. Cl. 30/304

(57) ABSTRACT

A multi-bladed cutting apparatus for slicing objects, such as food items, into slices. The blades of the apparatus may comprise a curvature to thereby allow the apparatus to be utilized using a rocking cut motion. In one embodiment, the apparatus may have removable blades to thereby allow a user to vary the width of the slices cut by the apparatus. The apparatus is particularly effective for cutting child-sized bites using a two cut procedure. The shape and design of the handle is ergonomic to thereby facilitate use of the apparatus.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Invention.

The present disclosure relates generally to cutting instruments with blades, and more particularly, but not necessarily entirely, to cutting instruments with multiple blades.

2. Description of Related Art

Modern cutting instruments for cutting objects, such as food items, typically comprise a single blade extending from a handle. A user may grasp the handle to thereby control the movement of the blade and to impart cutting motions onto the blade itself. Previously available blades may be formed from a wide variety of materials, including metals and plastics. In addition, previously available handles may be formed from a wide range of materials as well, including metals, wood and plastics. Some previously available cutting instruments have blades integrally formed with the handles, such as plastic knifes and butter knifes.

One drawback to using a cutting instrument of conventional design, i.e., a single-bladed design as described above, is the inability to efficiently and quickly cut bite-sized pieces. One attempt to overcome this drawback is shown in U.S. Design Pat. No. D508,383 issued to Endres et al. on Aug. 16, 2005 (the “'383 patent”). The '383 patent teaches a design for a utensil for cutting food into child-sized bites. The utensil includes a plurality of blades arranged in a side-by-side arrangement. The top edge of the blades are coupled to a bottom surface of a disk-shaped body. While apparently an improvement over a conventional design, the disk-shaped body appears difficult to grasp as no clear handle is present. Further, the blades on the utensil appear to be fixed into place and do not appear to be removable or adjustable, thus the width of the slices cut by the utensil does not appear to be variable. This is disadvantageous, since often times a user may wish to increase or decrease the width of the slices.

Despite the advantages of known cutting instruments, improvements are still being sought as the previously available devices are characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a schematic view of a cutting apparatus made in accordance with the principles of the present disclosure;

FIG. 2 is a side view of a blade for use with the cutting apparatus depicted in FIG. 1;

FIG. 3 is a cross-sectional view of the cutting apparatus taken along the section A—A shown in FIG. 1;

FIG. 4 is a side view of another embodiment of a cutting apparatus pursuant to the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

Applicant has discovered a novel cutting instrument that permits a user to efficiently and quickly slice objects, such as food items, into slices and bite-sized pieces. The cutting instrument includes a plurality of blades arranged in a side-by-side arrangement. The blades may include curved cutting edges and a handle of ergonomic design to facilitate the use of a rocking cut motion. In one embodiment, the blades are selectively removable from a coupling member to thereby allow a user to vary the width of the slices cut by the device.

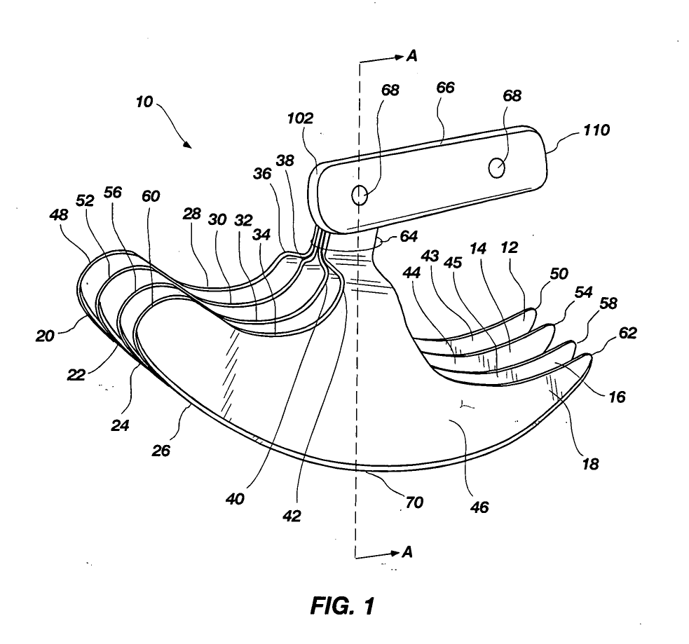

Referring now to FIG. 1, there is an apparatus 10 for cutting an object into slices. The apparatus 10 is particularly adapted for cutting and slicing food items into bite-sized pieces in just two cutting actions. The apparatus 10 includes a plurality of blades 12, 14, 16 and 18 that are arranged in a side-by-side cutting arrangement. Each of the blades 12, 14, 16 and 18 is separated from adjacent blades by a gap in the side-by-side cutting arrangement.

Referring now to blade 12, blade 12 comprises a cutting edge 20 on its lowermost portion. The cutting edge 20 may be sharpened to any desired sharpness, including in the range from dull to extremely sharp, depending upon the intended use of the apparatus 10. For example, the sharpness of the cutting edge 20 may be varied for safety purposes in the event that the apparatus 10 may be used by children or the cutting edge 20 may be extremely sharp if the intended use of the apparatus 10 is for cutting meat. The blade 12 may include a top edge 28 opposite from the cutting edge 20. Interposed between the top edge 28 and the cutting edge 20 is a body portion 43. The body portion 43 may be solid and rigid such that the blade 12 does not bend or deform while the apparatus 10 is in use. The blade 12 may further include a first end 48 and a second end 50. The top edge 28 and the cutting edge 20 may intersect at the first end 48 and the second end 50. Extending from the top edge 28 of the blade 12 is a shanked portion 36 whose purpose and function will be explained hereinafter.

Referring now to blade 14, blade 14 also comprises a cutting edge 22 on its lowermost portion. The cutting edge 22 may be sharpened to any desired sharpness, including in the range from dull to extremely sharp, depending upon the intended use of the apparatus 10. For example, the sharpness of the cutting edge 22 may be varied for safety purposes in the event that the apparatus 10 may be used by children or the cutting edge 22 may be extremely sharp if the intended use of the apparatus 10 is for cutting meat. The blade 14 may include a top edge 30 opposite from the cutting edge 22. Interposed between the top edge 30 and the cutting edge 22 is a body portion 44. The body portion 44 may be solid and rigid such that the blade 14 does not bend or deform while the apparatus 10 is in use. The blade 14 may further include a first end 52 and a second end 54. The top edge 30 and the cutting edge 22 may intersect at the first end 52 and the second end 54. Extending from the top edge 30 of the blade 14 is a shanked portion 38 whose purpose and function will be explained hereinafter.

Referring now to blade 16, blade 16 also comprises a cutting edge 24 on its lowermost portion. The cutting edge 24 may be sharpened to any desired sharpness, including in the range from dull to extremely sharp, depending upon the intended use of the apparatus 10. For example, the sharpness of the cutting edge 24 may be varied for safety purposes in the event that the apparatus 10 may be used by children or the cutting edge 24 may be extremely sharp if the intended use of the apparatus 10 is for cutting meat. The blade 16 may include a top edge 32 opposite from the cutting edge 24. Interposed between the top edge 32 and the cutting edge 24 is a body portion 45. The body portion 45 may be solid and rigid such that the blade 16 does not bend or deform while the apparatus 10 is in use. The blade 16 may further include a first end 56 and a second end 58. The top edge 32 and the cutting edge 24 may intersect at the first end 56 and the second end 58. Extending from the top edge 32 of the blade 16 is a shanked portion 40 whose purpose and function will be explained hereinafter.

Referring now to blade 18, blade 18 also comprises a cutting edge 26 on its lowermost portion. The cutting edge 26 may be sharpened to any desired sharpness, including in the range from dull to extremely sharp, depending upon the intended use of the apparatus 10. For example, the sharpness of the cutting edge 26 may be varied for safety purposes in the event that the apparatus 10 may be used by children or the cutting edge 26 may be extremely sharp if the intended use of the apparatus 10 is for cutting meat. The blade 18 may include a top edge 34 opposite from the cutting edge 26. Interposed between the top edge 34 and the cutting edge 26 is a body portion 46. The body portion 46 may be solid and rigid such that the blade 18 does not bend or deform while the apparatus 10 is in use. The blade 18 may further include a first end 60 and a second end 62. The top edge 34 and the cutting edge 26 may intersect at the first end 60 and the second end 62. Extending from the top edge 34 of the blade 18 is a shanked portion 42 whose purpose and function will be explained hereinafter.

As can be seen in FIG. 1, the shanked portions 36, 38, 40, and 42 all converge at and pass through a common neck 64 where they are coupled together by a coupling member 66. In particular, the coupling member 66 may include fasteners 68 that extend into the coupling member 66 and through bores in the shanked portions 36, 38, 40, and 42. At least one of the fasteners 68 may be removable from the coupling member 66 to thereby allow the blades 12, 14, 16 and 18 to be selectively removed from the coupling member 66. In one embodiment, the fasteners 68 comprise male threaded shafts that engage a nut or a female threaded shaft to thereby secure the blades 12, 14, 16, and 18 to the coupling member 66. The coupling member 66 may also serve as a handle to thereby allow a user to grasp, hold, and cut using the apparatus 10. It will be understood that the fasteners 68 may comprise any type of fastener, including screws, bolts, nuts, couplers, and the like. In one alternative embodiment, the coupling member 66 permanently couples the shanked portions 36, 38, 40 and 42 together. This may be done by welding, bonding, or any other manner. The coupling member 66 may be integrally formed with the shanked portions 36, 38, 40, and 42, that is, they are all formed from a single material whether poured or molded.

It will be appreciated by those having ordinary skill in the art that the blades 12, 14, 16 and 18 may be formed from plastic or metal depending upon the intended use of the apparatus 10. Plastic may be desirable due to its low cost and ease of manufacture. However, metal may be utilized if the strength of the blades 12, 14, 16, and 18 is at issue. For example, plastic may be utilized to form the blades 12, 14, 16 and 18 if the apparatus 10 is only intended to cut soft items, such as toast or dough. If, on the other hand, the blades 12, 14, 16 and 18 are intended to cut tough or fibrous items, such as meat or vegetables, metal may be required to form the blades 12, 14, 16 and 18. The blades 12, 14, 16 and 18 may be formed of other materials, such as ceramic, although less desirable.

As can be observed in FIG. 1, the apparatus 10 is depicted with four (4) blades, namely blades 12, 14, 16 and 18. It will be understood that the number of blades shown in FIG. 1 is not limiting on the present disclosure as the applicant's invention may comprise more or less blades than four (4). For example, in one embodiment of the present disclosure, an apparatus for cutting may comprise five (5) blades. In another embodiment of the present disclosure, the apparatus may comprise three (3) blades. Thus, it will be understood that an apparatus in accordance with the applicant's invention may include a plurality of blades.

Describing now the shape of the cutting edge 26 of the blade 18, it will be understood that the description of the cutting edge 26 of blade 18 is likewise applicable to the shapes of the cutting edges 20, 22, 24 of blades 12, 14, and 16, respectively. As observed in FIG. 1, when the blade 18 is observed from its side, the cutting edge 26 has a curvature, i.e., the cutting edge is not flat as the cutting edge 26 deviates upwards from a center portion 70 of the cutting edge 26 as it approaches the first end 60 and the second end 62 of the blade 18. The curved nature of the cutting edge 26 allows the apparatus 10 to be utilized with a rocking cut motion. In a rocking cut motion, one of the first end 60 or the second end 62 of the blade 18 is placed on the item to be cut. The user then rocks the blade 18 forwards or backwards, as the case may be, rocking the cutting edge 26 of the blade 18 onto the item to be cut. This “rocking motion” may be repeated several times until the cut is accomplished. Because the cutting edges 20, 22, and 24 are all shaped similarly to the cutting edge 26, it will be understood that all of the cutting edges 20, 22, 24 and 26 will cut and slice most efficiently when they are rocked back and forth on the item to be cut.

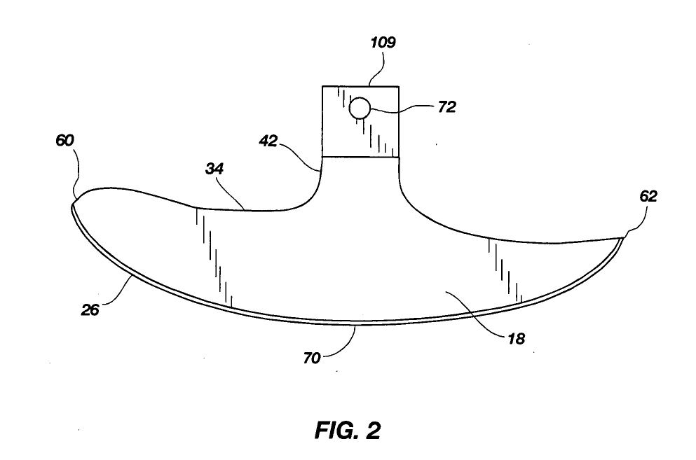

Referring now to FIG. 2, there is depicted a side view of the blade 18. The shanked portion 42 of the blade 18 extends upwardly from the top edge 34 of the blade 18 and approximately the mid-portion of the top edge 34. Located near a terminal end 109 of the shanked portion 42 of the blade 18 is a mounting hole 72. It will be understood that the shanked portions 36, 38, and 40 of blades 12, 14, and 16, respectively, may each include a mounting hole similar to mounting hole 72. As will be discussed below, the mounting hole 72 facilitates securing the blade 18 to the coupling member 66.

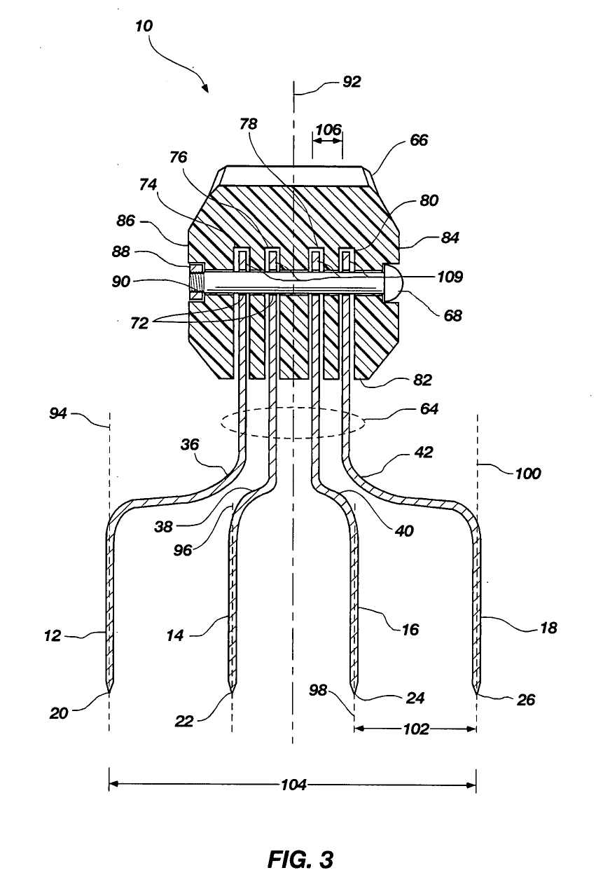

Referring now to FIG. 3, there is depicted a cross-sectional view of the apparatus 10 taken along the section A-A shown in FIG. 1. The blades 12, 14, 16 and 18 reside generally below the coupling member 66. The coupling member 66 includes rectangular slots 74, 76, 78 and 80 that extend upwardly from a lower surface 82 of the coupling member 66. The shanked portions 36, 38, 40 and 42 of the blades 12, 14, 16 and 19, respectively, extend into slots 74, 76, 78 and 80, respectively, from the lower surface 82 of the coupling member 66. The fastener 68 extends from a side surface 84 of the coupling member 66 and through the mounting holes 72 in each of the blades 12, 14, 16 and 18 to a side surface 86 of the coupling member 66. A nut 88 is secured to a threaded end 90 of the fastener 68. In this manner, the blades 12, 14, 16 and 18 are secured to the coupling member 66. Recesses may be provided in the side surfaces 84 and 86 into which a head of the fastener 68 and the nut 88 are mounted, respectively.

It will be appreciated that other types of fasteners may be utilized in lieu of fastener 68 to secure the blades 12, 14, 16 and 18. For example, a “quick release” type fastener may be used (not shown in the figures). One form of a quick-release type fastener suitable for use with the present invention includes a lever connected to one end of a rod. The rod is passed through the coupling member 66 and the mounting holes 72 in the blades 12, 14, 16 and 18 with the lever in an open position. Secured to the free end of the rod is a fastener that threadably engages the rod. The fastener is finger tightened onto the rod until it engages the coupling member 66. The lever is then closed to further tighten the quick release and hence the engagement of the blades 12, 14, 16 and 18 and the coupling member 66. Another type of fastener suitable for securing the blades 12, 14, 16 and 18 includes a spring activated catch that engages the mounting holes 72 as the terminal ends 109 of the blades 12, 14, 16 and 18 are inserted into the coupling member 66. That is, the blades 12, 14, 16 and 18 click into place via the catch as the blades are inserted into the slots 74, 76, 78, and 80 of the coupling member 66. A lever or other suitable means may be utilized to withdraw the spring loaded catch (not shown in the figures) such that the blades 12, 14, 16, and 18 can be released when desired. Another type of fastener suitable for securing the blades 12, 14, 16 and 18 includes a twist lock mechanism (not shown in the figures). The twist lock mechanism may include a twist ring that, when rotated, includes catches that engage the mounting holes 72 (or slots on the blades 12, 14, 16 and 18). To release the blades 12, 14, 16 and 18, the twist ring may be rotated in the opposite direction from the engagement direction.

Passing though the center of the coupling member 66 is a central plane 92. The blades 12 and 14 are located on one side of the central place 92 and blades 16 and 18 are located on the opposite side of the central plane 92. It will be noted that the shanked portions 36 and 38 of the blades 12 and 14, respectively, extend inwardly towards the central plane 92. Likewise, the shanked portions 40 and 42 of the blades 14 and 16, respectively, extend inwardly towards the central plane 92. Each of the shanked portions 36, 38, 40, and 42 can therefore be said to comprise a lateral component, since each of the shanked portions 36, 38, 40, and 42 extends inwardly towards the central plane 92 when the apparatus 10 is oriented as shown in FIG. 3. Further, each of the shanked portions 36, 38, 40, and 42 can also be said to comprise a vertical component, since each of the shanked portions 36, 38, 40, and 42 extends upwardly towards the coupling member 66 when the apparatus 10 is oriented as shown in FIG. 3. It will further be noted that the terminal ends 109 of the shanked portions 36, 38, 40 and 42, i.e., those portions of the shanks that extend into the slots 74, 76, 78, and 80, are parallel to the central plane 66. As can be seen in FIG. 3, each of the blades 12, 14, 16 and 18 comprises a cutting plane 94, 96, 98, and 100, respectively. The cutting planes 94, 96, 98 and 100 are all parallel to the central plane 92. It will be noted that the shanked portions 36, 38, 40 and 42 each diverges from their respective cutting planes 94, 96, 98, 100 towards the central plane 92.

While in the arrangement depicted in FIG. 3, each of the blades 12, 14, 16 and 18 are all separated from directly adjacent blades by a gap. The widths of these gaps are all equal and are generally represented by the double arrow indicated with reference numeral 102. It will be noted that the terminal ends 109 of the shanked portions 36, 38, 40 and 42 are also separated by a gap. The widths of these gaps are all equal and are generally represented by the double arrow indicated with reference numeral 106. It will be noted that the width of the gaps between the blades 12, 14, 16 and 18 are wider than the gaps of their respective shanked portions 36, 38, 40 and 42. In one embodiment, the width 102 is in the range from approximately one-half inch to approximately three inches. The blades 12 and 18 should be recognized as the outermost blades of the apparatus 10. The blades 12 and 18 are separated by a distance indicated by the double arrows marked with the reference numeral 104. In one embodiment, the distance 104 is in the range from approximately one and one-half inches to approximately nine inches.

It will be noted that any of the blades 12, 14, 16 and 18 may be removed from the coupling member 66. For example, to increase the width of the slices cut by the apparatus 10, the two innermost blades, 14 and 16, may be selectively removed from the coupling member 66. Alternatively, all but one of the blades 12, 14, 16 and 18 may be removed from the apparatus 10 such that only a single cutting edge is present. The inner blades 14 and 16 may also be placed in the outer slots 74 and 80. In this manner, the apparatus 10 includes multiple configurations as the blades 12, 14, 16 and 18 may be selectively removed from the apparatus 10. This selective feature widens the utility of the apparatus 10.

Referring back to FIG. 1, in use, a user grasps the coupling member 66 as a handle such that a free end 110 of the coupling member 66 extends away from the user's wrist, body and hand. That is, the free end 110 extends through the space between the user's index finger and thumb while an attached end 102 of the coupling member 102 is positioned near a user's pinky finger and wrist. This method of grasping and holding the coupling member 66 permits easy cutting using a rocking cut as the user rolls his or her wrist forward. The first ends 48, 52, 56, and 60 of the blades 12, 14, 16 and 18, respectively, are rounded and dulled to thereby prevent injury to a user's wrist or arm. The second ends 50, 54, 58 and 62 of the blades 12, 14, 16 and 18 may be relatively sharper that the first ends 48, 42, 56 and 60 since they are more likely not to come into contact with a user's wrist or arm. It will be noted that the coupling member 66, when used as a handle, is cantilevered as shown in FIG. 1. That is, the free end 110 of the coupling member 66 is unsupported.

It will be noted that the design of the blades 12, 14, 16 and 18 may be varied, including their width, height, composition, and sharpness. In addition, although only four (4) blades are shown depicted in relation to apparatus 10, any number of blades may be employed as discussed above. Further, striations (not shown in the figures) may be included on the blades 12, 14, 16 and 18.

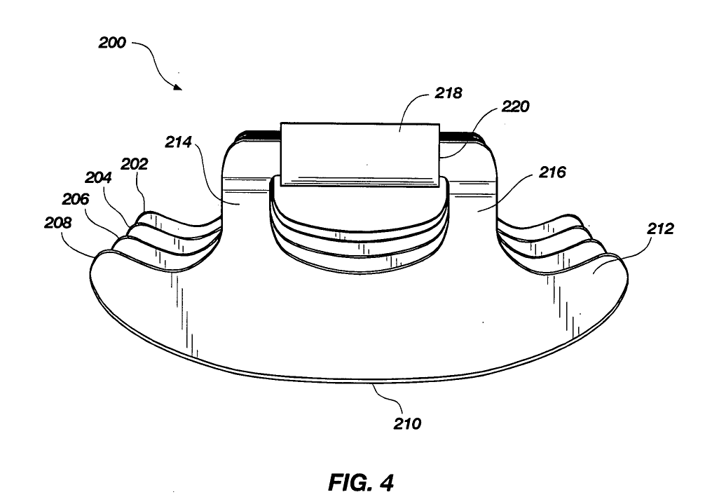

Referring now to FIG. 4, there is depicted another embodiment of an apparatus pursuant to the present disclosure indicated generally by reference numeral 200. The apparatus 200 includes blades 202, 204, 206, and 208 that are positioned in a side-by-side cutting arrangement. The blades 202, 204, 206, and 208 may be separated from any adjacent blades by a gap. Referring now to blade 208, with the understanding that blades 202, 204 and 206 have similar features, blade 208 comprises a cutting edge 210 on its lowermost portion and a top edge 212 opposite the cutting edge 210. Extending upwardly from the top edge 212 are a pair of shanked portions 214 and 216. Extending between the shanked portions 214 and 216 of the blade 208 is a cross-piece member 220. The cutting edge 210 may have a curvature to thereby allow a rocking cut motion as explained above. In another embodiment, the cutting edge 210 may have no curvature or limited curvature.

The blades 202, 204, 206 and 208 may be fixed in the side-by-side arrangement by a coupling member 218. The coupling member 218 may engage the cross-piece members of each of the blades 202, 204, 206 and 208 via slots, similar to coupling member 66 (see FIG. 3). Again, a wide variety of fasteners, some of which have been previously described, may be used to fixidly secure the blades 202, 204, 206 and 208 to the coupling member 218. In one embodiment, the fastener comprises a pair of bolts with nuts. The shanked portions of each of the blades 202, 204, 206 and 208, may diverge from their respective cutting planes towards a central plane of the apparatus 200 such that each of the shanked portions comprises a lateral component.

It should be noted that the blades 202, 204, 206, and 208 and the coupling member 218 may be integrally formed as a single component or as separate components. Again, any suitable materials may be utilized, including metal and plastic, for the components. In addition, the coupling member 218 may serve as a handle to thereby allow a user to grasp the apparatus 10 with his or her hand. Any of the blades 202, 204, 206, and 208 may be selectively removable from the coupling member 218 to thereby provide different gaps between the blades.

Those having ordinary skill in the relevant art will appreciate the advantages provided by the features of the present disclosure. For example, it is a feature of the present disclosure to provide a multi-bladed cutting apparatus. Another feature of the present disclosure is to provide such a cutting apparatus capable of using a rocking cut motion to slice food items. It is a further feature of the present disclosure, in accordance with one aspect thereof, to provide a cutting apparatus with blades that are selectively removable to thereby vary the width of the slices cut by the apparatus.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A cutting apparatus comprising:
a plurality of blades, each of the plurality of blades comprising a cutting edge, a body and a first shanked portion; and
a coupling member for securing the first shanked portions of the plurality of blades into a cutting arrangement such that the bodies of each of the plurality of blades are disposed in a side-by-side arrangement and such that each of the cutting edges is separated from adjacent cutting edges by a gap.

2. The cutting apparatus of claim 1, wherein the cutting edge of each of the plurality of blades has a curvature to thereby facilitate use of a rocking cut maneuver.

3. The cutting apparatus of claim 1, wherein each of the first shanked portions of the plurality of blades is separated from any adjacent first shanked portions by a gap in the cutting arrangement.

4. The cutting apparatus of claim 3, wherein the plurality of blades comprises a first blade and a second blade that are adjacent to each other in the cutting arrangement, the gap between cutting edges of the first blade and the second blade measuring a first distance and the gap between the first shanked portions of the first blade and the second blade measuring a second distance, wherein the first distance is greater than the second distance.

5. The cutting apparatus of claim 1, wherein each cutting edge lies in a cutting plane, and wherein each first shanked portion diverges from the cutting plane of its associated cutting edge.

6. The cutting apparatus of claim 5, further comprising a central plane, wherein each of the first shanked portions of the plurality of blades diverges from the cutting plane of its associated cutting edge towards the central plane.

7. The cutting apparatus of claim 6, wherein the plurality of blades are grouped into a first group and a second group, the first group residing on a first side of the central plane and the second group residing on a second side of the central plane.

8. The cutting apparatus of claim 7, wherein the first shanked portions of each of the plurality of blades in the first group and the second group has a terminal portion that lies in a plane parallel to the central plane.

9. The cutting apparatus of claim 1, further comprising a cantilevered handle connected to the first shanked portions of each of the plurality of blades.

10. The cutting apparatus of claim 1, wherein each of the plurality of blades comprises a second shanked portion, said first shanked portion and said second shanked portion being interconnected.

11. The cutting apparatus of claim 10, further comprising a handle connected to the first and second shanked portions.

12. A handheld apparatus for cutting objects into slices, said apparatus comprising:
a plurality of blades, said plurality of blades grouped into a first group and a second group; and
a coupling member for selectively receiving and fixing into a cutting arrangement either the first group of the plurality of blades or the second group of the plurality of blades;
wherein the slices cut by the first group of blades have a first width and the slices cut by the second group of blades have a second width, wherein the first width and the second width are unequal.

13. The handheld apparatus of claim 12, wherein the blades of the second group are a subset of the blades of the first group.

14. The handheld apparatus of claim 12, wherein each of the plurality of blades comprises a shanked portion, said coupling member having a plurality of slots for removably receiving the shanked portions of the plurality of blades.

15. The handheld apparatus of claim 14, wherein said coupling member comprises a locking mechanism for securing the plurality of blades into the slots.

16. The handheld apparatus of claim 12, wherein said coupling member is integrated into a handle.

17. The handheld apparatus of claim 16, wherein said handle is cantilevered.

18. A method for cutting objects into slices, said method comprising the steps of:
providing a plurality of blades;
selecting a first group of blades from the plurality of blades;
installing the first group of blades into a coupling device and locking the first group of blades into a first cutting arrangement; and
cutting the object into slices.

19. The method of claim 18, wherein the step of cutting the object into slices comprises the step of employing a rocking cut maneuver.

20. The method of claim 18, further comprising the steps of removing the first group of blades from the coupling device, selecting and installing a second group of blades into the coupling device, and locking the second group of blades into a second cutting arrangement, wherein said second cutting arrangement is distinct from said first cutting arrangement.
